(19) United States
(12) Patent Application Publication
(10) Pub. No.: US 2018/0177137 A1
(43) Pub. Date: Jun. 28, 2018

(54) FLOWERPOT AND METHOD OF MANUFACTURING THE SAME

(71) Applicant: William Gregory Dodd, Long Beach, CA (US)

(72) Inventor: William Gregory Dodd, Long Beach, CA (US)

(21) Appl. No.: 15/392,057

(22) Filed: Dec. 28, 2016

(51) Int. Cl. A01G 9/02; B28B 1/16; B28B 7/00

(52) U.S. Cl. CPC A01G 9/021; B28B 7/00; B28B 1/16

(57) ABSTRACT

A flowerpot and method of manufacture of a flowerpot. The flowerpot includes an outer peripheral surface covered with a grid of tiles.

### FIELD OF THE INVENTIONS

The inventions described below relate to the field of flowerpots.

### SUMMARY

The devices and methods described below provide for a flowerpot and method of manufacture of a flowerpot. The flowerpot is formed by first forming an outer surface of the flowerpot from within an outer mold. The outer mold supports a plastic grid so that tiles are positioned into the grid within the outer mold. Optionally, adhesive can be applied to the tiles. Then, an inner mold is placed within the outer mold to create an annular space between the outer mold and the inner mold. Concrete is then poured within the annular space created between the outer mold and the inner mold and allowed to cure. Once the concrete is cured, the inner mold and sand are removed to create the inner surface of the flowerpot.

### BRIEF DESCRIPTION OF THE DRAWINGS

FIG. 1 is a perspective view of a flowerpot.

FIG. 2 is a top view of the flowerpot.

FIG. 3 is a cut away view of an outer mold and removable inner mold used to form the flowerpot.

FIG. 4 is a top view of the outer mold used to form the flowerpot.

### DETAILED DESCRIPTION OF THE INVENTIONS

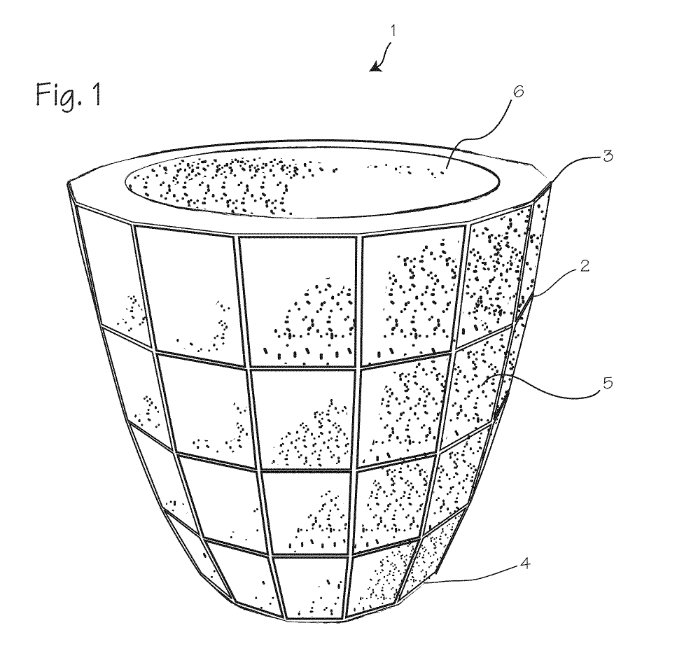

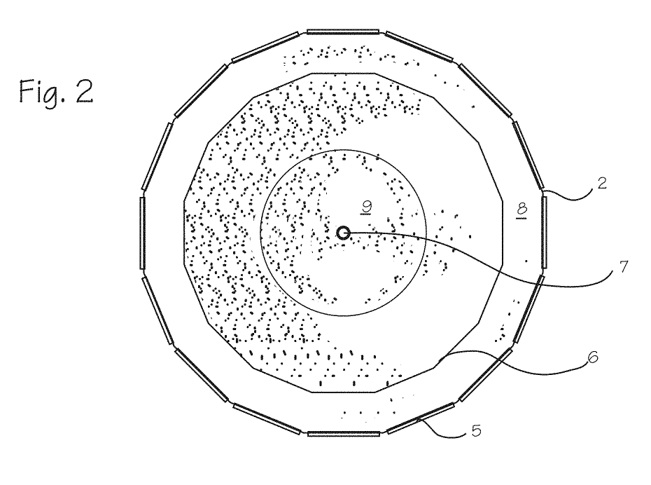

FIG. 1 is a perspective view of a flowerpot 1 constructed according to the methods described below. The flowerpot includes an outer surface 2 having an upper end 3 and a lower end 4. The outer surface is covered with a grid of tiles 5. The flowerpot also has an inner surface 6 that forms an inner retaining surface for retaining a floral grouping or a plant. The inner surface may be cylindrical, frustroconical or any other radially symmetrical shape. The flowerpot may include a drainage hole 7 on the bottom of the flowerpot, as depicted in FIG. 2.

The tile used to create the outer surface may be of any type that is suitable for adhering to an upright surface, such as porcelain, mosaic, glass, granite, travertine or marble.

FIG. 2 is a top view of the flower pot 1. Poured concrete is contained between the outer surface 2 and the inner surface 6. The concrete between the outer surface 2 and the inner surface 6 forms an upper rim or lip 8 of the flowerpot. The upper rim or lip may be surfaced with tile that matches or accents the tile on the surface of the outer surface of the flowerpot. The flowerpot may also include a drainage hole 7 on the bottom of the flowerpot 9.

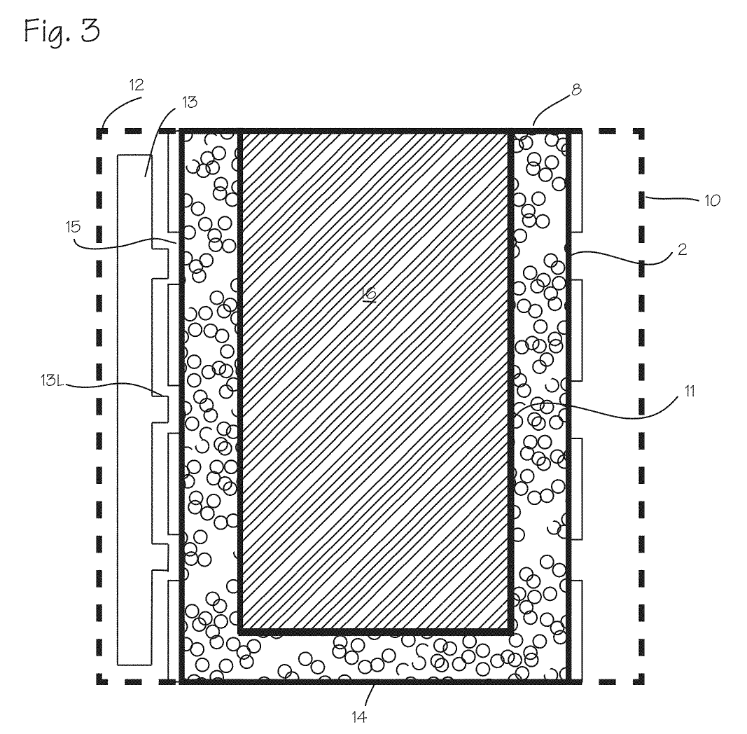

FIG. 3 is a cut away view of an outer mold or template 10 and removable inner mold 11 used to form the flowerpot. The flowerpot is formed by first creating the outer surface 2 of the flowerpot within the outer mold. The outer mold maybe anything, but it is consistently formed with a frame 12 that supports a plastic grid 13 inside the outer mold. The outer mold has a bottom surface 14 and a plurality of upwardly protruding side surfaces 15 with the grid 13 set within the frame 12. A first row of tiles is positioned into the plastic grid closest to the bottom surface of the outer mold. Additional rows of tiles are positioned at grid lines 13L, above the first row, until the plastic grid is completely filled with tiles. The positioned tiles can be positioned into place by friction fit that does not require adhesion. Alternatively, the positioned tiles are covered with adhesive, such as mortar or ready-mix plaster, in order to set the tiles into place. The tiles are then leveled out and tapped until they are evenly spaced within the plastic grid. The adhesive is allowed to dry, if necessary, and the assembly is grouted to fill in the gaps between the tiles. The dried assembly forms the outer surface 2 of the flowerpot.

A inner mold 11 is then placed within the assembly inside the outer mold. If necessary, the inner mold is filled with sand 16 to prevent its walls from collapsing or bowing. The inner mold is centered within the outer mold in order to obtain even wall thickness on all sides. The inner mold is smaller than the assembly so that when the inner mold is placed within the assembly, an annular space is created between the assembly and the inner mold. Concrete is then poured within the annular space created between the assembly and the inner mold. The sides of the filled form may be agitated to help remove air bubbles from the mix. The concrete is allowed to cure and then the inner mold and sand are removed to create the inner surface of the flowerpot. The concrete between the tiles and the inner surface forms an upper rim or lip 8 of the flowerpot. The upper rim or lip may be surfaced with tile that matches or accents the tile on the surface of the outer surface of the flowerpot. The outer mold is then broken away to reveal the formed flowerpot.

Optionally, drainage holes may be formed on the bottom surface of the flowerpot. If the drainage hole is formed during the formation process of the flowerpot, a hole is cut into the bottom of the mold and an insert is positioned within the mold. Concrete is then poured up to, but not covering, the insert. Once the first pour hardens, the removable inner liner mold is placed within the assembly and pressed into the concrete until the bottom of the inner mold rests on top of the drainage hole. The inner mold is then filled with sand and additional concrete is poured within the annular channel as described above. Alternatively, if the drainage hole is formed after the formation process of the flowerpot, the drainage hold is cut through the bottom of the flowerpot 9. Pipe or other suitable drainage material maybe inserted into the cut hole.

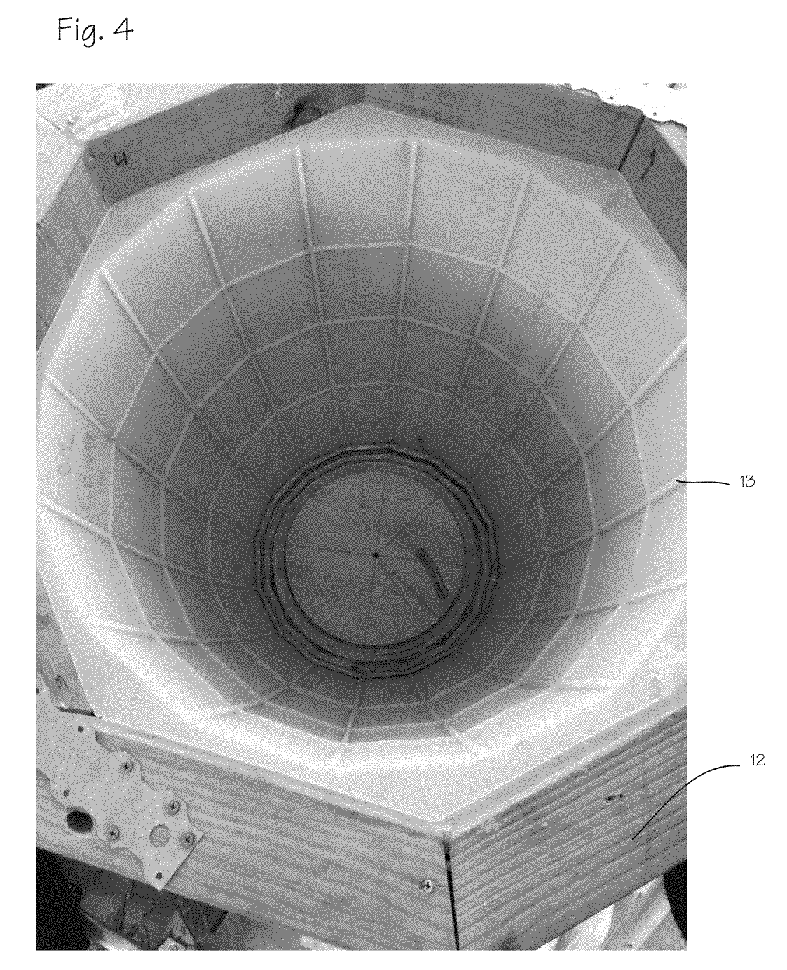

FIG. 4 is a top view of the outer mold used to form the flowerpot. The outer mold supports a plastic grid 13. A first row of tiles is positioned into the plastic grid 13 beginning at the bottom surface of the outer mold. Additional rows of tiles are positioned above the first row until the plastic grid is completely filled with tiles. The tiles can be friction fit into the plastic grid and then grouted into place. Alternatively, the positioned tiles are covered with adhesive such as mortar or ready-mix plaster in order to set into place. The adhesive is allowed to dry, if necessary, and the assembly is then grouted. Alternatively, once the tiles are positioned within the grid, adhesive may be applied to the tile outer surfaces so that the tiles are secured in the outer mold, and the adhesive is then removed after removing the outer mold.

While the preferred embodiments of the devices and methods have been described in reference to the environment in which they were developed, they are merely illustrative of the principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

We claim:

1. A method of manufacturing a flowerpot comprising the steps of:
forming an outer surface of the flowerpot by positioning tiles within a grid of an outer mold;
securing the tiles into the grid of the outer mold to create an assembly;
inserting an inner mold within the assembly so that an annular cavity is formed between the assembly and the inner mold;
pouring concrete into the annular cavity to fill the annular cavity;
removing the inner mold when the concrete is cured to create an inner surface of the flowerpot; and
removing the outer mold.

2. The method of manufacturing a flower pot of claim 1 wherein further comprising the step of applying adhesive to the tiles of the grid of the outer mold after securing the tiles into the grid of the outer mold to create an assembly.

3. A flowerpot comprising:
an outer surface having an upper end and a lower end wherein the outer surface is covered with a grid of tiles;
an inner surface that forms an inner retaining surface for retaining a floral grouping or a plant wherein; and
a concrete upper rim or lip between the outer peripheral surface and the inner peripheral surface;
wherein the space between the inner surface and outer surface is filled with concrete.
